(19) United States
(12) Patent Application Publication
(10) Pub. No.: US 2015/0033306 A1
(43) Pub. Date: Jan. 29, 2015

(54) APPARATUS AND METHOD FOR SYSTEM USER AUTHENTICATION

(71) Applicant: International Business Machines Corporation, Armonk, NY (US)

(72) Inventors: Gary I. Dickenson, Tucson, AZ (US); Richard Hutzler, Tucson, AZ (US)

(73) Assignee: International Business Machines Corporation, Armonk, NY (US)

(21) Appl. No.: 13/951,216

(22) Filed: Jul. 25, 2013

(51) Int. Cl. G06F 21/31

(52) U.S. Cl. CPC G06F 21/31
USPC 726/7

(57) ABSTRACT

An apparatus for user authentication includes an input module that receives an authentication token, a counter module that increments a count of the number of authentication tokens received, a security module that determines whether the authentication token matches a valid authentication token for the user, prompts the user for another authentication token in response to determining that the authentication token does not match the valid authentication token, and provides the user simulated access to an electronic system in response to determining that (i) the count of the number of authentication tokens received is equal to one and (ii) the authentication token matches the valid authentication token, and an access module that provides the user authentic access to the electronic system in response to determining that (i) the count of the number of authentication tokens received is greater than one and (ii) the authentication token matches the valid authentication token.

### FIELD

The subject matter disclosed herein relates to user authentication and more particularly relates to computer and electronic system user authentication.

### BACKGROUND

Conventional user authentication schemes employ the use of authentication tokens such as passwords, personal identification numbers, biometrics, or some combination thereof. Access to computer and electronic systems often only requires entry of a single authentication token. Passwords or personal identification numbers stored by users or organizations may be compromised through brute force attacks, computer malware, and social engineering. For example, key logging software on an unsecured or shared computer allows an intruder to surreptitiously monitor a user's keystrokes to learn of the user's password or personal identification number. An unauthorized user with a valid authentication token may gain full access to the authorized user's personal information, including financial data. Conventional user authentication systems validate the authentication token but not the process by which the authentication token was entered or received.

### BRIEF SUMMARY

An apparatus for system user authentication includes an input module, a counter module, a security module, and an access module. The input module, in one embodiment, receives an authentication token during a user authentication session. The counter module, in one embodiment, increments a count of the number of authentication tokens received during the user authentication session in response to receiving the authentication token. In another embodiment, the counter module determines whether the count of the number of authentication tokens received during the user authentication session equals or exceeds a minimum number of authentication attempts required during the user authentication session. In yet another embodiment, the counter module determines whether the count of the number of authentication tokens received during the user authentication session exceeds a maximum number of authentication attempts allowed during the user authentication session.

The security module, in one embodiment, determines whether the authentication token matches a valid authentication token for the user. In another embodiment, the security module prompts the user for another authentication token in response to determining that the authentication token does not match the valid authentication token. In yet another embodiment, the security module provides the user simulated access to a computing or electronic system in response to determining that (i) the count of the number of authentication tokens received during the user authentication session is equal to one and (ii) the authentication token matches the valid authentication token. In a further embodiment, the security module provides the user simulated access to a computing or electronic system in response to determining that (i) the count of the number of authentication tokens received during the user authentication session is less than a minimum number of required authentication attempts during the user authentication session and (ii) the authentication token matches the valid authentication token. In a particular embodiment, the security module prompts the user for another authentication token in response to determining that (i) the count of the number of authentication tokens received during the user authentication session is less than or equal to a maximum number of allowed authentication attempts during the user authentication session and (ii) the authentication token does not match the valid authentication token. In other embodiments, the security module determining that the authentication token does not match the valid authentication token includes determining that the authentication token is a variation of the valid authentication token. In some embodiments, the security module determining that the authentication token does not match the valid authentication token includes determining that the entry of the authentication token required no corrections.

The access module, in one embodiment, provides the user authentic access to a computing or electronic system in response to determining that (i) the count of the number of authentication tokens received during the user authentication session is greater than one and (ii) the authentication token matches the valid authentication token. In another embodiment, the access module provides the user authentic access to a computing or electronic system in response to determining that (i) the count of the number of authentication tokens received during the user authentication session equals or exceeds a minimum number of authentication attempts required during the authentication session and (ii) the authentication token matches a valid authentication session. In a further embodiment, the access module provides the user authentic access to a computing or electronic system in response to determining that (i) the count of the number of authentication tokens received during the user authentication session is less than or equal to a maximum number of authentication attempts allowed during the authentication session and (ii) the authentication token matches a valid authentication session.

An authentication token may include one or more of a password, a personal identification number, an image, a gesture pattern, and a biometric identifier. A variation of an authentication token may include one or more of transposing two or more elements of the authentication pattern, inserting one or more elements into the authentication token, deleting one or more elements from the authentication token, and changing one or more elements of the authentication token. In one embodiment, the user authentication session may be a pre-determined time period. In another embodiment, the user authentication session may be a preset number of authentication attempts.

A method to authenticate system users includes receiving an authentication token during a user authentication session, incrementing a count of the number of authentication tokens received during the user authentication session in response to receiving the authentication token, determining whether the authentication token matches a valid authentication token for the user, prompting the user for another authentication in response to determining that the authentication token does not match a valid authentication token for the user, providing the user simulated access to a computing or electronic system in response to determining that (i) the count of the number of authentication tokens received during the user authentication session is equal to one and (ii) the authentication token matches the valid authentication token, and providing the user authentic access to a computing or electronic system in response to determining that (i) the count of the number of authentication tokens received during the user authentication session is greater than one and (ii) the authentication token matches the valid authentication token.

In an embodiment, the method includes determining whether the count of the number of authentication tokens received during the user authentication session equals or exceeds a minimum number of authentication attempts required during a user authentication session. The method, in another embodiment, also provides the user simulated access to a computing or electronic system in response to determining that (i) the count of the number of authentication tokens received during the user authentication session is equal to one and (ii) the authentication token matches the valid authentication token. In yet another embodiment, the method provides the user authentic access to a computing or electronic system in response to determining that (i) the count of the number of authentication tokens received during the user authentication session equals or exceeds the minimum number of authentication attempts required during the authentication session and (ii) the authentication token matches a valid authentication token.

The method, in one embodiment, includes determining whether the count of the number of authentication tokens received during a user authentication session exceeds a maximum number of authentication attempts allowed during the user authentication session. In another embodiment, the method includes prompting the user for another authentication token in response to determining that (i) the count of the number of authentication tokens received during the user authentication session does not exceed a maximum number of allowed authentication attempts during the user authentication session and (ii) the authentication token matches a valid authentication token. In a further embodiment, the method includes providing the user authentic access to a computing or electronic system in response to determining that (i) the count of the number of authentication tokens received during the user authentication session is less than or equal to a maximum number of authentication attempts allowed during the authentication session and (ii) the authentication token matches a valid authentication session.

A computer program product for user authentication, the computer program product receives an authentication token during a user authentication session, incrementing a count of the number of authentication tokens received during the user authentication session in response to receiving the authentication token, determines whether the authentication token matches a valid authentication token for the user, prompts the user for another authentication in response to determining that the authentication token does not match a valid authentication token for the user, provides the user simulated access to a computing or electronic system in response to determining that (i) the count of the number of authentication tokens received during the user authentication session is equal to one and (ii) the authentication token matches the valid authentication token, and provides the user authentic access to a computing or electronic system in response to determining that (i) the count of the number of authentication tokens received during the user authentication session is greater than one and (ii) the authentication token matches the valid authentication token.

In an embodiment, the computer program product determines whether the count of the number of authentication tokens received during the user authentication session equals or exceeds a minimum number of authentication attempts required during a user authentication session. The computer program product, in another embodiment, provides the user simulated access to a computing or electronic system in response to determining that (i) the count of the number of authentication tokens received during the user authentication session is equal to one and (ii) the authentication token matches the valid authentication token. In yet another embodiment, the computer program product provides the user authentic access to a computing or electronic system in response to determining that (i) the count of the number of authentication tokens received during the user authentication session equals or exceeds the minimum number of authentication attempts required during the authentication session and (ii) the authentication token matches a valid authentication token.

The computer program product, in one embodiment, determines whether the count of the number of authentication tokens received during a user authentication session exceeds a maximum number of authentication attempts allowed during the user authentication session. In another embodiment, the computer program product prompts the user for another authentication token in response to determining that (i) the count of the number of authentication tokens received during the user authentication session does not exceed a maximum number of allowed authentication attempts during the user authentication session and (ii) the authentication token matches a valid authentication token. In a further embodiment, the computer program product provides the user authentic access to a computing or electronic system in response to determining that (i) the count of the number of authentication tokens received during the user authentication session is less than or equal to a maximum number of authentication attempts allowed during the authentication session and (ii) the authentication token matches a valid authentication session.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for user authentication;

FIG. 2 is a schematic block diagram illustrating one embodiment of an apparatus for user authentication;

FIG. 3 is a schematic flow chart illustrating one embodiment of a method for user authentication;

FIG. 4 is a schematic flow chart illustrating another embodiment of a method for user authentication; and

FIG. 5 is a schematic flow chart illustrating a further embodiment of a method for user authentication.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

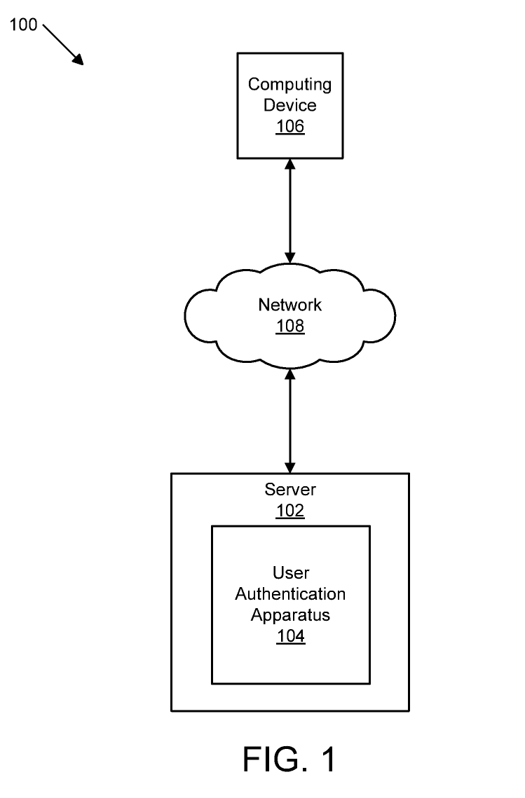

FIG. 1 is a schematic block diagram illustrating one embodiment of a system for user authentication. The system 100 includes a server 102 with a user authentication apparatus 104 connected to a computing device 106 through a network 108, which are described below.

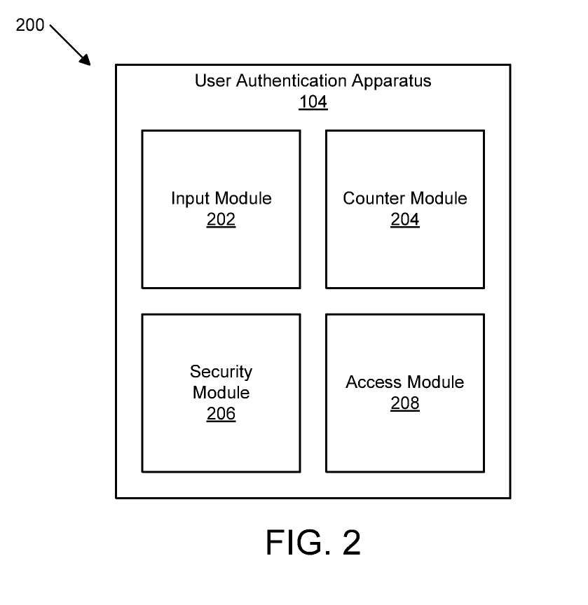

The system 100 includes a server 102 with a user authentication apparatus 104. In certain configurations, the user authentication apparatus 104 may reside on the computing device 106. In other configurations, the user authentication apparatus may reside partially on the server 104 and partially on the computing device 106. The user authentication apparatus 104 receives authentication tokens via the computing device 106. The user authentication apparatus is described in more detail with respect to the apparatus 200 in FIG. 2. The network 108 connecting the server 102 and the computing device 106 may include a local area network (“LAN”), a wide area network (“WAN”), a wireless network, a cellular network, the Internet, or the like. The server 102 may be any computer accessible by a computing device 106 over a network 108, including but not limited to a mainframe server.

FIG. 2 is a schematic block diagram of one embodiment of an apparatus 200 for user authentication. The apparatus 200 include one embodiment of a user authentication apparatus 104 with an input module 202, counter module 204, security module 206, and access module 208, which are described below.

The input module 202 receives authentication tokens via a computing device 106 during a user authentication session. In one embodiment, the input module 202 resides on the computing device 106. In another embodiment, the input module 202 resides on the server 102. An authentication token maybe anything capable of authenticating a system user. An authentication token may take the form of a password, a number, an image, a gesture pattern, or a biometric identifier. A password may contain one or more letters, numerals, and symbols (e.g., @, #, !). A gesture pattern may contain one or more geometric patterns. In some embodiments, the gesture pattern may include a specific sequence of gestures forming the pattern. A biometric identifier may include a fingerprint, a palm print, a voice signature, an iris pattern, facial recognition, and the like. In certain embodiments, the voice signature may include reading aloud pre-selected text. In some embodiments, the input module 202 detects whether an entry of the authentication token included a correction before the authentication token was submitted. For example, the input module 202 may detect that a user deleted one or more characters from a password authentication token before it was submitted for validation.

A user authentication session is a time period during which a user may use his or her authentication token to access a computing or electronic system. In one embodiment, the user authentication session will expire or terminate after a limited time period. The user authentication session, in another embodiment, expires or terminates after a specific number of authentication attempts. Expiration or termination of a user authentication session may require a user to wait a certain amount of time before the user may reattempt to authenticate and access the computing or electronic system. Alternatively, expiration or termination of a user authentication session may require a reset of the computing or electronic system before a user may reattempt to authenticate and access the computing or electronic system.

The counter module 204 increments a count of the number of authentication tokens received during a user authentication session in response to the input module 202 receiving the authentication token. In one embodiment, the counter module 204 resides on the computing device 106. In another embodiment, the counter module 204 resides on the server 102. At the start of a user authentication session, the count of the number of authentication tokens received during the user authentication session starts at zero. Each time an authentication token is received by the input module 202, the counter module 204 increments the count of the number of authentication tokens received by one. When a user authentication session expires, the count of the number of authentication tokens received is reset to zero.

In one embodiment, the counter module 204 determines whether the count of the number of authentication tokens received during a user authentication session equals or exceeds a minimum number of required authentication attempts during the user authentication session. In this embodiment, a user is granted authentic access to a computing or electronic system after a minimum number of authentication attempts. This requirement provides an extra layer of security in a situation where an unauthorized individual knows a user's authentication token, but does not know that a specific number of authentication attempts is required before he or she can gain authentic access to the computing or electronic system. The counter module 204, in another embodiment, determines whether the count of the number of authentication tokens received during a user authentication session exceeds a maximum number of allowed authentication attempts during the user authentication session. This requirement provides an extra layer of security against brute force attempts to access a computing or electronic system by repeatedly guessing a user's authentication token.

The security module 206 determines whether the authentication token received by the input module 202 matches a valid authentication token for the user. In one embodiment, the security module 206 resides on the computing device 106. In another embodiment, the security module 206 resides on the server 102. A user may have one or multiple valid authentication tokens. In a certain embodiment, the one or more valid authentication tokens for a user may be stored on the server 102. Alternatively, the one or more valid authentication tokens for a user may be stored on the computing device 106.

In one configuration, the security module 206 prompts the user for another authentication token in response to determining that the authentication token received by the input module 202 does not match a valid authentication token. Determining that the received authentication token does not match a valid authentication token, in one configuration, includes determining that the received authentication token is a variation of the valid authentication token. The variation of the authentication token, in a certain configuration, can take the form of one or more of transposing two or more elements of the valid authentication token, inserting one or more elements into the valid authentication token, deleting one or more elements from the valid authentication token, and changing one or more elements of the valid authentication token. For example, given a valid authentication token such as “password,” the security module 206 may recognize that the term “wordpass” is a transposition of “password.” Similarly, the security module 206 may recognize that the terms “password5,” “passwrd,” and “bassword” are variations of “password.” In another configuration, determining that the received authentication token does not match a valid authentication token includes determining that the entry of the authentication required no corrections. For example, given a valid authentication token such as “1234567890,” the security module 206 may require that when a user types “1234567890,” he or she has to mistype the authentication token (e.g., “1234578906”) and correct the mistake before submitting the authentication token. In some configurations, the input module 202 may detect whether a user made and corrected a mistake in the entry of the authentication token before submitting the authentication token.

The security module 206 provides the user simulated access to a computing or electronic system in response to determining that the first authentication token received during the user authentication session is a valid authentication token. Simulated access mimics a native computing environment of the computing or electronic system without granting the user access to authentic data. The computing or electronic system may be the server 102 or the computing device 106. The data may be one or more of user data, data relating to the accessed computing or electronic system, or data on networks accessible from the accessed computing or electronic system. In one configuration, simulated access provides the user access to a set of false data. In another configuration, simulated access does not provide the user access to any data. In a further configuration, simulated access include monitoring or recording user activity within the simulated computing environment. The monitoring may include logging the IP address of the computing device 106, a timestamp of the simulated access, and recording the user using audiovisual components of the computing device 106, such as an attached or integrated camera, an integrated microphone, or the like. In yet another configuration, simulated access may include real-time notification of the simulated access to security personnel or law enforcement authorities. This security scheme assumes that the user, by entering a valid authentication on the first attempt, is not the authorized user but an unauthorized user. Providing the unauthorized user simulated access to the computing or electronic system upon entry of a valid authentication entry on the first attempt allows may lead to the identification of the intruder. Furthermore, if the intruder discovers that he or she is in a simulated computing environment, the intruder may be led to believe that the valid authentication token is invalid and discard it. The security module 206, in one configuration, determines that the received authentication token is the first authentication token received during the user authentication session by determining that the count of the number of authentication tokens received during the authentication session is equal to one. In one configuration, the user is required to reboot the computing device 102 to exit the simulated computing environment. In another configuration, the user may enter a valid authentication token to exit the simulated computing environment into the authentic computing environment.

In a configuration where a minimum number of authentication attempts are required, the security module 206 provides the user simulated access to a computing or electronic system in response to determining that (i) the count of the number of authentication attempts received during the user authentication session has not equaled or exceeded the minimum number of required authentication attempts and (ii) the received authentication token matches a valid authentication token. In a configuration where a maximum number of authentication attempts are allowed, the security module 206 terminates the user authentication session in response to determining that the count of the number of authentication attempts received during the user authentication session has exceeded the maximum number of allowed authentication attempts. In the same configuration, the security module 206 prompts the user for another authentication token in response to determining that (i) the count of the number of authentication tokens received during the user authentication session is less than the maximum number of allowed authentication attempts and (ii) the authentication token received does not match the valid authentication token.

The access module 208 provides a user authentic access to a computing or electronic system. Authentic access includes full access to the computing or electronic system in accordance with the rights and permissions of the user. In one embodiment, the access module 208 resides on the computing device 106. In another embodiment, the access module 208 resides on the server 102. The access module 208 provides the user authentic access to the computing or electronic system in response to determining that the authentication token received matches a valid authentication token and that it was not the first authentication token received during the user authentication session. In one embodiment, the access module 208 determines that the authentication token received is not the first authentication token received during the user authentication session by determining that the count of the number of authentication tokens received during the user authentication session is greater than one.

In a configuration where a minimum number of authentication attempts are required, the access module 208 provides the user authentic access to a computing or electronic system in response to determining that (i) the count of the number of authentication attempts received during the user authentication session exceeds the minimum number of required authentication attempts and (ii) the received authentication token matches a valid authentication token. In a configuration where a maximum number of authentication attempts are allowed, the access module 208 provides the user authentic access to a computing or electronic system in response to determining that (i) the count of the number of authentication tokens received during the user authentication session is less than the maximum number of allowed authentication attempts and (ii) the authentication token received matches the valid authentication token.

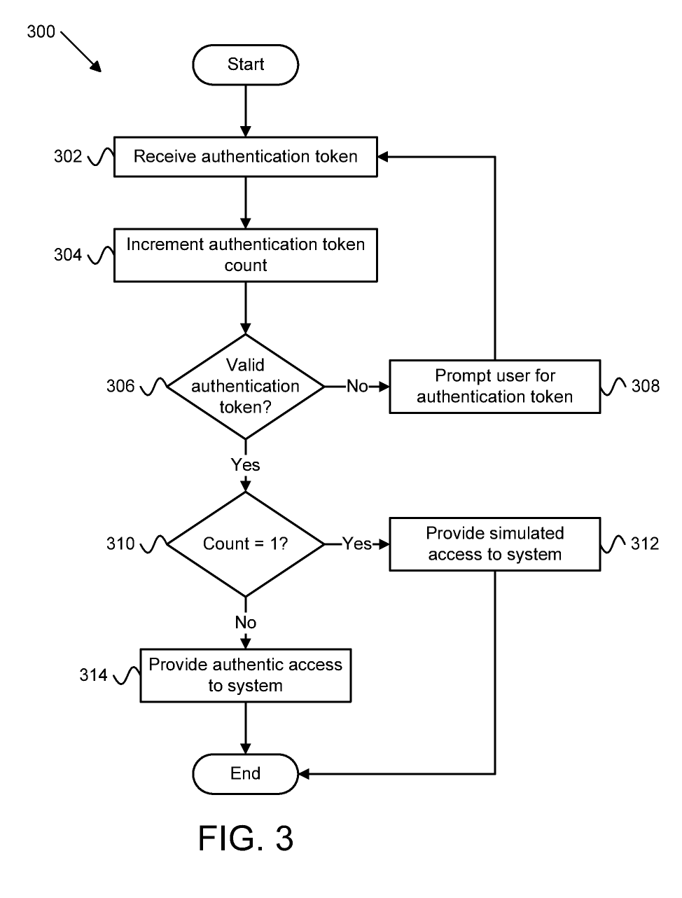

FIG. 3 is a schematic flow chart illustrating one embodiment of a method 300 for user authentication. The method 300 begins and receives 302 an authentication token via the computing device 106. Next, the method 300 increments 304 a count of the number of authentication tokens received by one. The method 300 determines 306 whether the authentication token received is a valid authentication token. If the authentication token received is not a valid authentication token, the method 300 prompts 308 the user for another authentication token. Alternatively, if the authentication token received is a valid authentication token, the method 300 determines 310 if the count of the number of authentication tokens received is equal to one. If the count of the number of authentication tokens received is equal to one, the method 300 provides 312 the user simulated access to the computing or electronic system and the method 300 ends. Alternatively, if the count of the number of authentication tokens received is not equal to one, the method 300 provides 314 the user authentic access to the computing or electronic system and the method 300 ends.

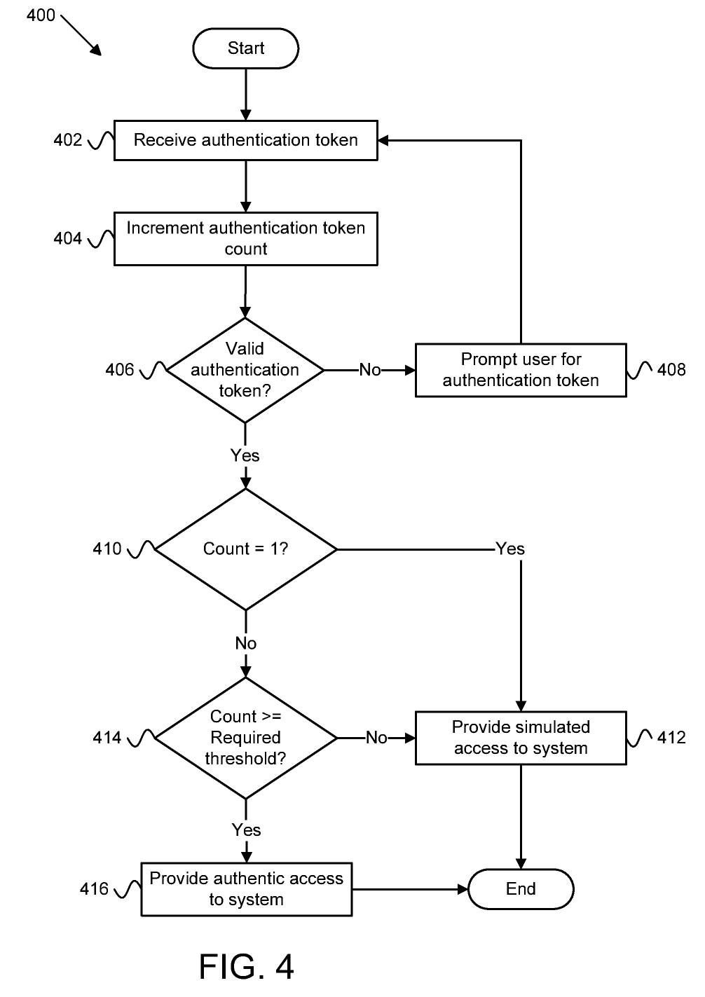

FIG. 4 is a schematic flow chart illustrating another embodiment of a method 400 for user authentication. The method 400 begins and receives 402 an authentication token via the computing device 106. Next, the method 400 increments 404 a count of the number of authentication tokens received by one. The method 400 determines 406 whether the authentication token received is a valid authentication token. If the authentication token received is not a valid authentication token, the method 400 prompts 408 the user for another authentication token. Alternatively, if the authentication token received is a valid authentication token, the method 400 determines 410 if the count of the number of authentication tokens received is equal to one. If the count of the number of authentication tokens received is equal to one, the method 400 provides 412 the user simulated access to the computing or electronic system. Alternatively, if the count of the number of authentication tokens received is not equal to one, the method 400 determines 414 if the count of the number of authentication tokens received equals or exceeds the minimum number of required authentication attempts for the user authentication session. If the count of the number of authentication tokens received is less than the minimum number of required authentication attempts, the method 400 provides 412 the user simulated access to the computing or electronic system and the method 400 ends. Alternatively, if the count of the number of authentication tokens received equals or exceeds the minimum number of required authentication attempts, the method 400 provides 416 the user authentic access to the computing or electronic system and the method 400 ends.

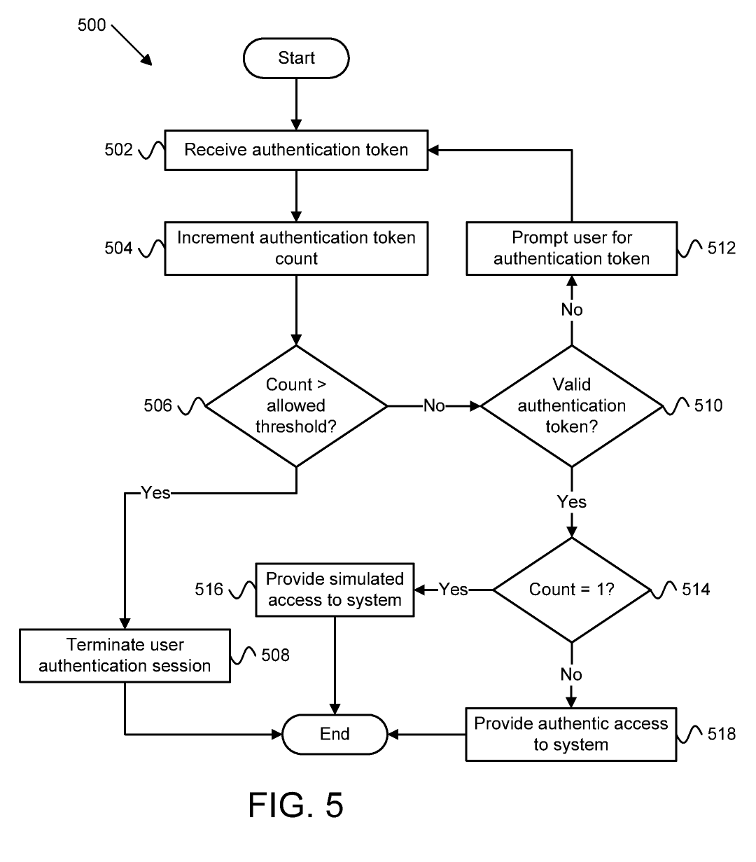

FIG. 5 is a schematic flow chart illustrating a further embodiment of a method 500 for user authentication. The method 500 begins and receives 502 an authentication token via the computing device 106. Next, the method 500 increments 504 a count of the number of authentication tokens received by one. The method 500 determines 506 if the count of the number of authentication tokens received exceeds the maximum number of allowed authentication attempts for the user authentication session. If the count of the number of authentication tokens received exceeds the maximum number of allowed authentication attempts, the method 500 terminates 508 the user authentication session and the method 500 ends. Alternatively, if the count of the number of authentication tokens received is less than the maximum number of allowed authentication attempts, the method 500 determines 510 whether the authentication token received is a valid authentication token. If the authentication token received is not a valid authentication token, the method 500 prompts 512 the user for another authentication token. Alternatively, if the authentication token received is a valid authentication token, the method 500 determines 514 if the count of the number of authentication tokens received is equal to one. If the count of the number of authentication tokens received is equal to one, the method 500 provides 516 the user simulated access to the computing or electronic system. Alternatively, if the count of the number of authentication tokens received does not equal one, the method 500 provides 518 the user authentic access to the computing or electronic system and the method 500 ends.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
an input module that receives an authentication token during a user authentication session;
a counter module that increments a count of the number of authentication tokens received during the user authentication session in response to receiving the authentication token;
a security module that
determines whether the authentication token matches a valid authentication token for the user;
prompts the user for another authentication token in response to determining that the authentication token does not match the valid authentication token; and
provides the user simulated access to a computing or electronic system in response to determining that (i) the count of the number of authentication tokens received during the user authentication session is equal to one and (ii) the authentication token matches the valid authentication token; and
an access module that provides the user authentic access to the computing or electronic system in response to determining that (i) the count of the number of authentication tokens received during the user authentication session is greater than one and (ii) the authentication token matches the valid authentication token,
wherein at least a portion of the input module, the counter module, the security module, and the access module comprise one or more of hardware and executable code, the executable code stored on one or more computer readable storage media.

2. The apparatus of claim 1, wherein
the counter module further determines whether the count of the number of authentication tokens received during the user authentication session equals or exceeds a minimum number of authentication attempts required during the user authentication session;
the security module further provides the user simulated access to a computing or electronic system in response to determining that (i) the count of the number of authentication tokens received during the user authentication session is less than a minimum of required authentication attempts during the user authentication session and (ii) the authentication token matches the valid authentication token; and
the access module further provides the user authentic access to the computing or electronic system in response to determining that (i) the count of the number of authentication tokens received during the user authentication session equals or exceeds a minimum number of authentication attempts required during the authentication session and (ii) the authentication token matches the valid authentication token.

3. The apparatus of claim 1, wherein
the counter module further determines whether the count of the number of authentication tokens received during the user authentication session exceeds a maximum number of authentication attempts allowed during the user authentication session;
the security module further prompts the user for another authentication token in response to determining that (i) the count of the number of authentication tokens received during the user authentication session is less than a maximum number of allowed authentication attempts during the user authentication session and (ii) the authentication token does not match the valid authentication token; and
the access module further provides the user authentic access to the computing or electronic system in response to determining that (i) the count of the number of authentication tokens received during the user authentication session is less than the maximum number of authentication attempts allowed during the authentication session and (ii) the authentication token matches the valid authentication token.

4. The apparatus of claim 1, wherein the authentication token comprises one or more of a password, a personal identification number, an image, a gesture pattern, and a biometric identifier.

5. The apparatus of claim 1, wherein the security module determines that the authentication token does not match the valid authentication token comprises determining that the authentication token comprises a variation of the valid authentication token.

6. The apparatus of claim 1, wherein the security module determines that the authentication token does not match the valid authentication token comprises determining that the entry of the authentication token required no corrections.

7. The apparatus of claim 5, wherein the variation of the valid authentication token comprises one or more of
transposing two or more elements of the valid authentication token;
inserting one or more elements into the valid authentication token;
deleting one or more elements from the valid authentication token; and
changing one or more elements of the valid authentication token.

8. A method for system user authentication comprising:
receiving an authentication token during a user authentication session;
incrementing a count of the number of authentication tokens received during the user authentication session in response to receiving the authentication token;
determining whether the authentication token matches a valid authentication token for the user;
prompting the user for another authentication token in response to determining that the authentication token does not match the valid authentication token;
providing the user simulated access to a computing or electronic system in response to determining that (i) the count of the number of authentication tokens received during the user authentication session is equal to one and (ii) the authentication token matches the valid authentication token; and
providing the user authentic access to the computing or electronic system in response to determining that (i) the count of the number of authentication tokens received during the user authentication session is greater than one and (ii) the authentication token matches the valid authentication token.

9. The method of claim 8, further comprising
determining whether the count of the number of authentication tokens received during the user authentication session equals or exceeds a minimum number of authentication attempts required during the user authentication session;
providing the user simulated access to a computing or electronic system in response to determining that (i) the count of the number of authentication tokens received during the user authentication session is less than a minimum number of required authentication attempts during the user authentication session and (ii) the authentication token matches the valid authentication token; and
providing the user authentic access to the computing or electronic system in response to determining that (i) the count of the number of authentication tokens received during the user authentication session equals or exceeds the minimum number of authentication attempts required during the authentication session and (ii) the authentication token matches the valid authentication token.

10. The method of claim 8, further comprising
determining whether the count of the number of authentication tokens received during the user authentication session exceeds a maximum number of authentication attempts allowed during the user authentication session;
prompting the user for another authentication token in response to determining that (i) the count of the number of authentication tokens received during the user authentication session is less than a maximum number of allowed authentication attempts during the user authentication session and (ii) the authentication token does not match the valid authentication token; and
providing the user authentic access to the computing or electronic system in response to determining that (i) the count of the number of authentication tokens received during the user authentication session is less than the maximum number of authentication attempts allowed during the authentication session and (ii) the authentication token matches the valid authentication token.

11. The method of claim 8, wherein the authentication token comprises one or more of a password, a personal identification number, an image, a gesture pattern, and a biometric identifier.

12. The method of claim 8, wherein determining that the authentication token does not match the valid authentication token comprises determining that the authentication token comprises a variation of the valid authentication token.

13. The method of claim 8, wherein determining that the authentication token does not match the valid authentication token comprises determining that the entry of the authentication token required no corrections.

14. The method of claim 12, wherein the variation of the valid authentication token comprises one or more of
transposing two or more elements of the valid authentication token;
inserting one or more elements into the valid authentication token;
deleting one or more elements from the valid authentication token; and
changing one or more elements of the valid authentication token.

15. A computer program product for system user authentication, the computer program product comprising a computer readable storage medium having program code embodied therein, the program code readable/executable by a processor to:
receive an authentication token during a user authentication session;
increment a count of the number of authentication tokens received during the user authentication session in response to receiving the authentication token;
determine whether the authentication token matches a valid authentication token for the user;
prompt the user for another authentication token in response to determining that the authentication token does not match the valid authentication token;
provide the user simulated access to a computing or electronic system in response to determining that (i) the count of the number of authentication tokens received during the user authentication session is equal to one and (ii) the authentication token matches the valid authentication token; and
provide the user authentic access to the computing or electronic system in response to determining that (i) the count of the number of authentication tokens received during the user authentication session is greater than one and (ii) the authentication token matches the valid authentication token.

16. The computer program product of claim 15, the program code further configured to
determine whether the count of the number of authentication tokens received during the user authentication session equals or exceeds a minimum number of authentication attempts required during the user authentication session;
provide the user simulated access to a computing or electronic system in response to determining that (i) the count of the number of authentication tokens received during the user authentication session is less than a minimum number of required authentication attempts during the user authentication session and (ii) the authentication token matches the valid authentication token; and
provide the user authentic access to the computing or electronic system in response to determining that (i) the count of the number of authentication tokens received during the user authentication session equals or exceeds the minimum number of authentication attempts required during the authentication session and (ii) the authentication token matches the valid authentication token.

17. The computer program product of claim 15, the program code further configured to
determine whether the count of the number of authentication tokens received during the user authentication session exceeds a maximum number of authentication attempts allowed during the user authentication session;
prompt the user for another authentication token in response to determining that (i) the count of the number of authentication tokens received during the user authentication session is less than a maximum number of allowed authentication attempts during the user authentication session and (ii) the authentication token does not match the valid authentication token; and
provide the user authentic access to the computing or electronic system in response to determining that (i) the count of the number of authentication tokens received during the user authentication session is less than the maximum number of authentication attempts allowed during the authentication session and (ii) the authentication token matches the valid authentication token.

18. The computer program product of claim 15, wherein the authentication token comprises one or more of a password, a personal identification number, an image, a gesture pattern, and a biometric identifier.

19. The computer program product of claim 15, wherein determining that the authentication token does not match the valid authentication token comprises determining that the authentication token comprises a variation of the valid authentication token.

20. The computer program product of claim 19, wherein the variation of the valid authentication token comprises one or more of
transposing two or more elements of the valid authentication token;
inserting one or more elements into the valid authentication token;
deleting one or more elements from the valid authentication token; and
changing one or more elements of the valid authentication token.
